(19) United States
(12) Patent Application Publication
(10) Pub. No.: US 2010/0014033 A1
(43) Pub. Date: Jan. 21, 2010

(54) BASE MATERIAL FOR DISPLAY PANEL, METHOD FOR MANUFACTURING THE BASE MATERIAL, AND DISPLAY PANEL

(75) Inventors: Kaori Kawasaki, Matsudo-shi (JP); Takanori Aono, Tokorozawa-shi (JP)

Correspondence Address: OLIFF & BERRIDGE, PLC, P.O. BOX 320850, ALEXANDRIA, VA, 22320-4850, US

(73) Assignee: DAI NIPPON PRINTING CO., LTD, TOKYO (JP)

(21) Appl. No.: 12/448,843

(22) PCT Filed: Feb. 5, 2008
(86) PCT No.: PCT/JP2008/051852

§ 371 Date: Jul. 10, 2009

(30) Foreign Application Priority Data
Feb. 21, 2007 (JP) 2007-041369
Jan. 24, 2008 (JP) 2008-013969

(51) Int. Cl. G02F 1/13363; H01J 9/00

(52) U.S. Cl. 349/117; 445/58

(57) ABSTRACT

A liquid crystal display panel in which a retardation layer is disposed in the inner side of a cell is provided. The liquid crystal display panel can improve the close adhesiveness between the retardation layer in the seal region and the base material of the liquid crystal display panel substrate constituting the liquid crystal cell, whereby leakage of light can be prevented; the rigidity of the liquid crystal cell can be improved; and the common defects of each panel can be eliminated. Also, a display panel base material for such a liquid crystal display panel and a method of manufacturing the same are provided. On a sheet-shaped base material 10, there is laminated a retardation control layer 14 using the polymerizable liquid crystal as a material in which an anisotropic phase part 14a that is polymerized and cured with use of a metal mask 70 of a structure having another frame in the inside of a frame in a state in which a polymerizable liquid crystal serving as a material is oriented and an isotropic phase part 14b that is polymerized and cured in an isotropic state in which the polymerizable liquid crystal serving as a material is not oriented are arranged to be separated in a regional manner in the plane direction thereof. The isotropic phase part 14b is disposed in a region including at least a region predetermined to be sealed on the retardation control layer 14.

### TECHNICAL FIELD

The present invention relates to a retardation control plate and a display panel.

### BACKGROUND ART

In recent years, the market for a liquid crystal display panel of color display (hereafter also referred to as an LCD panel) is rapidly enlarging for a television display part, a portable terminal display part, for a display part of a personal computer, or the like due to the advantages such as a small thickness, a small weight, electric power consumption saving, and flickerlessness.

In such a liquid crystal display panel, a retardation film is conventionally used in order to control the retardation.

For example, typically in a liquid crystal panel of reflection type, in order to obtain circularly polarized light, a linear polarizing plate and a ¼λ retardation plate are used in combination.

Alternatively, in a liquid crystal panel of a perpendicular orientation mode (also referred to as a VA mode) widely used for television purpose, in order to reduce the viewing angle dependency thereof, a retardation film (also referred to as a negative C plate) having an optical axis perpendicular to the substrate and having a negative birefringence anisotropy and a retardation film (also referred to as a positive A plate) having an optical axis horizontal to the substrate and having a positive birefringence anisotropy are used in combination.

Besides these, a lot of retardation films are commercially available such as a viewing angle compensation film using a discotic liquid crystal.

Here, as shown in FIG. 6(a), a retardation layer (also referred to as an optical compensation layer) having a relationship of nₓ>n_{y}=n_{z} where a z-axis is taken in the normal direction of the layer plane S, an x-axis and a y-axis are taken in the directions that are perpendicular to each other in the layer plane S, and the refractive indices in the x-axis direction, the y-axis direction, and the z-axis direction are assumed to be nₓ, n_{y}, and n_{z}, respectively is a retardation layer having an optically positive monoaxial property in the layer plane S, and this is referred to as a positive A plate.

Also, as shown in FIG. 6(a), a retardation layer (optical compensation layer) having a relationship of nₓ=n_{y}>n_{z} is a retardation layer having an optically negative monoaxial property in the normal direction of the layer plane S, and this is referred to as a negative C plate.

All of the conventional retardation films are bonded to the outside of a liquid crystal cell (which may be simply referred to as a cell) being provided with a structure such that two sheets of substrates having a predetermined structure are opposed to each other and a liquid crystal is enclosed between the two sheets of substrates, so as to constitute a liquid crystal display device. Here, different retardation films are bonded with each other, or a retardation film and a polarizing plate are bonded through the intermediary of an adhesive agent. However, since the refractive indices of each retardation film, polarizing plate, and adhesive agent are different from each other, reflection of an external light is generated at the bonding interface, thereby inviting decrease in the display contrast.

In recent years, a liquid crystal material is used to provide the retardation layer, and the retardation layer is formed in a liquid crystal cell for controlling the retardation (Patent Document 1).

For example, as a liquid crystal material, a liquid crystal polymer and a liquid crystal monomer are available. The liquid crystal polymer has a glass transition point and is capable of freezing the liquid crystal structure thereof below the glass transition temperature. And the liquid crystal monomer has a reactive group such as an unsaturated bond in a molecular structure, capable of being cross-linked in a three-dimensional manner in a liquid crystal state and capable of freezing the liquid crystal structure. These liquid crystalline materials can be applied by being applied on a base material having an orientation function.

The retardation layer disposed within the liquid crystal cell in this manner can eliminate the drawbacks of the conventional retardation film bonded to the outside of the liquid crystal cell.

In the meantime, the retardation layer within the liquid crystal cell is disposed on either side of the two sheets of the sheet-shaped base materials (here, also referred to as a liquid crystal display panel base material) constituting the liquid crystal cell, and is typically formed on the liquid crystal cell side of the sheet-shaped base material where a color filter is formed.

For example, a sheet-shaped base material on the side where the color filter is formed on which the retardation layer constructed with a polymerizable liquid crystal is combined with an opposing base material, and a gap between the two is filled with a liquid crystal to constitute a liquid crystal cell. At this time, the two sheet-shaped base materials oppose each other while being spaced apart from each other by a predetermined gap, sealed with the seal material made from thermoset resin and UV curable resin, and the inside of the space formed with the sheet-shaped base material and the seal material is filled with the liquid crystal.

Then, since the retardation layer constructed with a polymerizable liquid crystal does not necessarily have a sufficient rigidity, a columnar resin cured product having a height of the same degree as the gap between the two substrates is patterned on the retardation layer or on the color filter, so as to keep the gap of the liquid crystal be constant.

However, in this case, when the close adhesiveness between the retardation layer and the sheet-shaped base material on the side where the color filter is formed is not sufficient, the retardation layer is exfoliated from the sheet-shaped base material, and orientation poorness is generated in the exfoliated part, thereby causing leakage of light, and leading to decrease in the rigidity of the liquid crystal cell as a whole.

In order to prevent this, so far various measures are taken such as addition of a silane coupling agent to the polymerizable liquid crystal or increase in the time for UV washing of glass.

However, even with these measures, one cannot make a sufficient close adhesiveness between the retardation layer and the sheet-shaped base material on the side where the color filter is formed, thereby raising a problem in view of the leakage of light or in view of the decrease in the rigidity of the liquid crystal cell as a whole.

### Patent Document 1: Japanese Patent Application Laid-Open (JP-A) No. 10-48627

### DISCLOSURE OF THE INVENTION

### Problem to be Solved by the Invention

In this manner, in recent years, a mode is adopted in which a retardation layer within a liquid crystal cell is disposed on either side of the two sheet-shaped base materials (also referred to as a display panel base material) constituting the liquid crystal cell, and is typically formed on the liquid crystal cell side of the plate-shaped substrate on which a color filter is formed. In accordance therewith, it will be important to take measures so as to prevent exfoliation of the retardation layer from the sheet-shaped base material due to the insufficient close adhesiveness between the retardation layer and the sheet-shaped base material on which the color filter is formed.

For this reason, various measures have been taken such as addition of a silane coupling agent to the polymerizable liquid crystal or increase in the time for UV washing of glass. However, with any of these measures, one cannot make a sufficient close adhesiveness between the retardation layer and the sheet-shaped base material on the side where the color filter is formed, so that an effective countermeasure therefor has been demanded.

The present invention meets this, and specifically aims at providing a liquid crystal display panel having a retardation layer disposed in the inside of a cell (i.e. in-cell type display panel), where the liquid crystal display panel can improve the close adhesiveness between the retardation layer in the seal region and the base material of the liquid crystal display panel substrate constituting the liquid crystal cell, whereby leakage of light can be prevented, and the rigidity of the liquid crystal cell can be improved. Also, the present invention aims at providing a display panel base material for such a liquid crystal display panel.

### Means for Solving the Problems

The display panel base material of the present invention is a display panel base material used in a display panel of in-cell type and having a retardation control layer disposed on a surface thereof, characterized in that, on a sheet-shaped base material, there is laminated the retardation control layer using the polymerizable liquid crystal as a material in which an anisotropic phase part that is polymerized and cured in a state in which a polymerizable liquid crystal serving as a material is oriented and an isotropic phase part that is polymerized and cured in an isotropic state in which the polymerizable liquid crystal serving as a material is not oriented, are arranged to be separated in a regional manner in a plane direction thereof, and that the isotropic phase part is disposed in a region including at least a region predetermined to be sealed on the retardation control layer.

Further, the display panel base material of the present invention is characterized in that the isotropic phase part is formed only in the region predetermined to be sealed.

Also, the display panel base material of the present invention is characterized in that the sheet-shaped base material is one in which a color filter is laminated on an upper side of the base material.

Also, the display panel base material of the present invention is characterized in that a black matrix layer is formed on a base material of the sheet base material; a color filter layer is formed at least in a space part of the black matrix layer; and the retardation control layer is laminated on the color filter layer.

Here, the “region predetermined to be sealed” means the whole region that is predetermined to be sealed.

Also, here, in the in-cell type display panel, it is assumed that, in the region predetermined to be sealed, the retardation layer is directly in contact with the base substrate surface of the sheet-shaped base material.

The method of manufacturing a display panel base material of the present invention is a method of manufacturing a display panel base material of the present invention, characterized by sequentially performing the steps of (a) applying an application liquid containing a polymerizable liquid crystal on a sheet-shaped base material to form a coating film or a coating layer; (b) orienting the polymerizable liquid crystal of the coating film to allow the coating film to have anisotropy; (c) selectively radiating an ionizing radiation such as ultraviolet rays onto the coating film allowed to have anisotropy, so as to polymerize and cure the polymerizable liquid crystal only at a part radiated with the ionizing radiation, so as to form an anisotropic phase part; and (d) heating the sheet-shaped base material on which the coating film having the anisotropic phase part is formed, so as to allow a non-cured part of the coating film to undergo phase transition to make the part isotropic, and polymerizing and curing the non-cured part in that state to form an isotropic part.

This method of manufacturing a display panel base material may be characterized in that a metal mask in which a frame-shaped frame part is formed in an inside of a frame-shaped outer frame is used in the step shown by (c), and the ionizing radiation is selectively radiated through the intermediary of the metal mask.

The display panel of the present invention is a display panel characterized in that a display panel base material of the present invention and an opposing base material are bonded through the intermediary of a seal material while keeping a predetermined gap in a region predetermined to be sealed on the display panel base material, and an inside thereof is filled with the liquid crystal and closely sealed.

### (Function)

Since the display panel base material of the present invention is constructed in the above stated manner, a display panel base material for manufacturing a display panel which has a retardation layer disposed in the inside of a cell is provided, whereby the close adhesiveness between the retardation layer in the seal region and the base material of the liquid crystal display panel substrate constituting the liquid crystal cell is improved and leakage of light is prevented, moreover the rigidity of the liquid crystal cell is improved.

Specifically, this is achieved by the fact that, on a sheet-shaped base material, there is laminated the retardation control layer using the polymerizable liquid crystal as a material in which an anisotropic phase part that is polymerized and cured in a state in which a polymerizable liquid crystal serving as a material is oriented and an isotropic phase part that is polymerized and cured in an isotropic state in which the polymerizable liquid crystal serving as a material is not oriented are arranged to be separated in a regional manner in a plane direction thereof, and that the isotropic phase part is disposed in a region including at least a region predetermined to be sealed on the retardation control layer.

More specifically, when an isotropic phase part is disposed in the region predetermined to be sealed of the retardation control layer, the close adhesiveness to the base material of the sheet-shaped base material will be higher as compared with a case in which an anisotropic phase part is disposed in the region predetermined to be sealed, whereby one can obtain a sufficient close adhesiveness between the retardation control layer in the region predetermined to be sealed and the base material, and one can eliminate leakage of light in the pixel region.

Namely, it is so constructed that the retardation control function can be normally exhibited in the anisotropic phase part of the retardation control layer.

At the same time, the rigidity of the cell ca be improved.

In a region corresponding to the image region, the anisotropic phase region of the retardation control layer exhibiting the retardation control function and the isotropic phase region of the retardation control layer not exhibiting the retardation control function are disposed in accordance with the intended object thereof.

For example, in a display panel base material for a liquid crystal display panel of transmission type, the whole image region is made to be an anisotropic phase part. In a display panel base material for a liquid crystal display panel of semi-transmission and semi-reflection type, the region of the anisotropic phase part and the region of the isotropic phase part are allowed to be present in a mixed manner in the image region.

As the display panel base material for a liquid crystal panel of transmission type, one can typically exemplify a mode in which the aforethe isotropic phase is formed only in the region predetermined to be sealed.

As the sheet-shaped base material for the aforethe display panel base material, there are those in a mode in which a color filter is laminated on a base material.

In particular, as the display panel base material, one can exemplify those in a mode in which a black matrix layer is formed on a base material of the aforethe sheet base material; a color filter layer is formed at least in a space part of the black matrix layer; and the aforethe retardation control layer is laminated on the color filter layer.

Since the method of manufacturing a display panel base material of the present invention is constructed in the above stated manner, a method of manufacturing a display panel base material for manufacturing a display panel which has a retardation layer disposed in the inside of a cell is provided, whereby the close adhesiveness between the retardation layer in the seal region and the base material of the display panel base material constituting the cell is improved and leakage of light is prevented, moreover the precision of the cell gap is improved.

Also, since the display panel of the present invention is constructed in this manner, a liquid crystal display panel having a retardation layer mounted in the inside of a cell can be provided that can improve the close adhesiveness between the retardation layer in the seal region and the base material of the display panel base material constituting the liquid crystal cell, whereby leakage of light can be prevented, and the rigidity of the cell can be improved.

### EFFECTS OF THE INVENTION

As described above, the present invention can provide a display panel having a retardation layer disposed in the inside of a cell, the display panel being capable of improving the close adhesiveness between the retardation layer in the seal region and the base material of the display panel base material constituting the cell, whereby leakage of light can be prevented, and the rigidity of the cell can be improved. Also, the present invention can provide a liquid crystal display panel base material with which one can manufacture such a liquid crystal display panel as well as a method of manufacturing the same. Also, in the method of manufacturing the same, in performing the step of forming an anisotropic phase part, by using a metal mask in which a frame-shaped frame part is formed in an inside of a frame-shaped outer frame, namely, a metal mask having a structure of having another frame in the inside of a frame, there is produced an effect of eliminating a common drawback on the display panel as compared with the case of using a commonly used photomask. Namely, in a case of using a photomask in performing the step of forming an anisotropic phase part, when dust is on the photomask, a problem is raised such that the shape of the dust is patterned on to almost all of products obtained by using the photomask. In contrast, in a case of using a metal mask in performing the step of forming an anisotropic phase part, such a problem is eliminated. Further, since a metal mask is generally less expensive than a photomask, a cost-down effect is also produced.

### BRIEF DESCRIPTION OF THE DRAWINGS

FIG. 1 is a schematic construction view of one example of an embodiment of a display panel base material of the present invention.

FIG. 2 is a schematic construction view of one example of an embodiment of a display panel of the present invention.

FIG. 3 is an exploded perspective view showing the liquid crystal display panel shown in FIG. 2, omitting the base material.

FIGS. 4(a), 4(b), 4(c), 4(d), and 4(e) are cross-sectional step views of one example of an embodiment of a method for manufacturing a display panel base material of the present invention.

FIG. 5 is a schematic view for describing a method of evaluating the close adhesion strength of a retardation control layer.

FIG. 6(a) is a view showing a positive A plate. FIG. 6(b) is a view showing a negative C plate.

FIG. 7(a) is a plan view showing an example of a relative arrangement position of an outer frame and a frame part in an example of a metal mask. FIG. 7(b) is a plan view showing one Example of a metal mask. FIG. 7(c) is a plan view showing one Example of a metal mask.

FIG. 8 is a view for describing a relative arrangement position between a base body in which a coating film is formed on a sheet-shaped base material and a metal mask.

### DESCRIPTION OF THE SYMBOLS

10 sheet-shaped base material
11 base material (here, glass substrate)
12 black matrix layer
12a black matrix frame
13 color filter layer
14 retardation control layer
14a anisotropic phase part
14b isotropic phase part
17a image region
17b seal region
20 sheet-shaped base material (also referred to as opposing base material or opposing substrate)
30 seal material
40 driving liquid crystal
41 polarizing plate
42 driving liquid crystal
42a orientation state in the lateral direction
43 positive C plate
44 color filter part
45 positive A plate
46 polarizing plate
51 sheet-shaped base material
52 polymerizable liquid crystal
53 ionizing radiation such as ultraviolet rays
54 anisotropic phase part
55a isotropic non-cured part
55 isotropic phase part
56 retardation control layer
61 base material (here, glass substrate)
62 retardation control layer
62a exfoliated retardation control layer
63 adhesive agent
64 stud pin
70 metal mask
71 light-shielding part
72 light-transmitting part
73 outer frame
74 frame part
75 connection part
76 region allotted to pixel
77 region predetermined to be sealed
78 base body

### BEST MODES FOR IMPLEMENTING THE INVENTION

An embodiment of the present invention will be described with reference to the drawings.

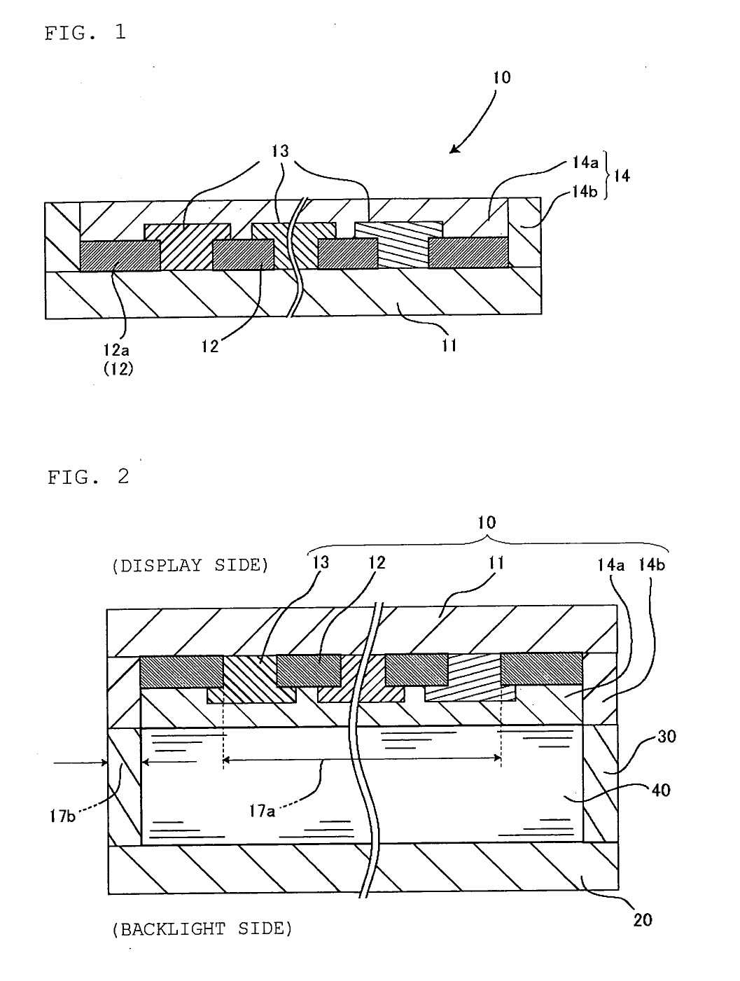

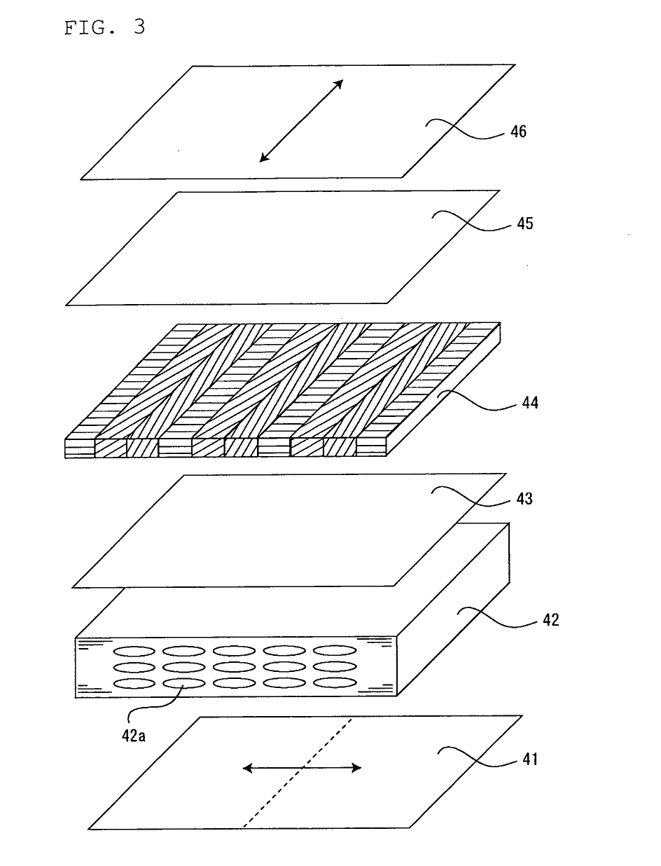

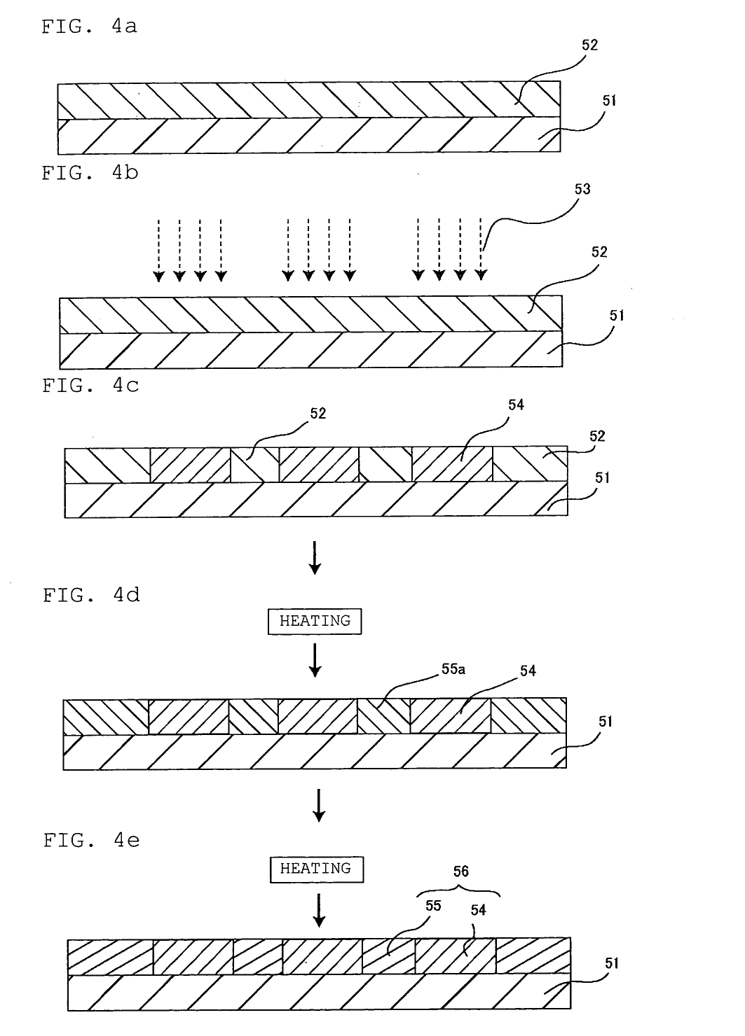

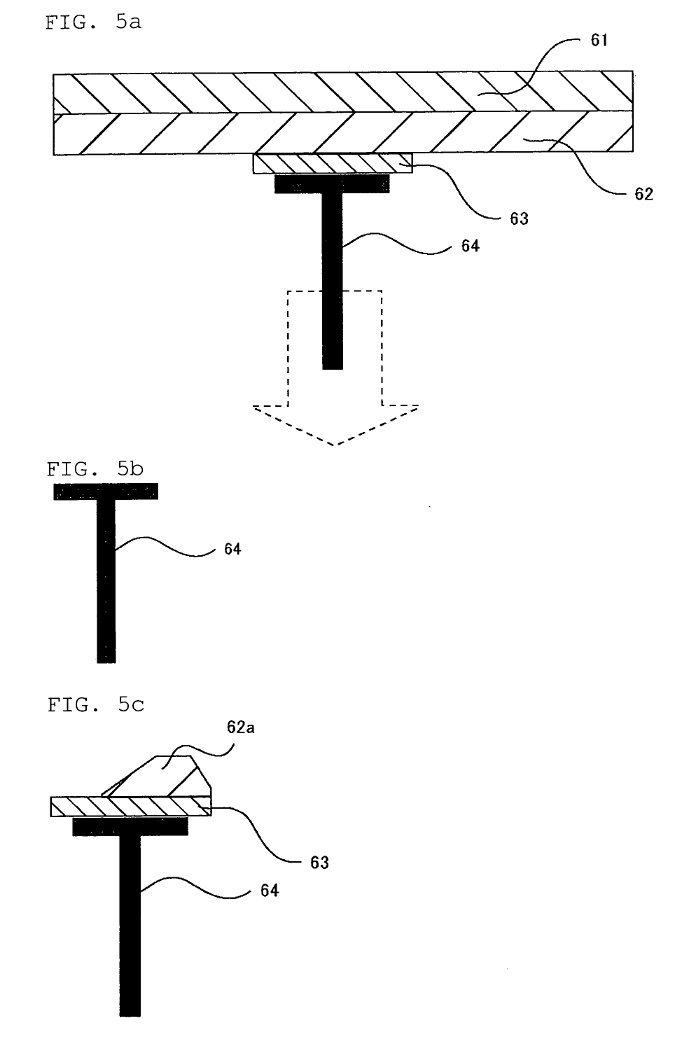

FIG. 1 is a schematic construction view of one example of an embodiment of a display panel base material of the present invention. FIG. 2 is a schematic construction view of one example of an embodiment of a display panel of the present invention. FIG. 3 is an exploded perspective view showing the display panel shown in FIG. 2, omitting the base material. FIGS. 4(a) to 4(e) are cross-sectional step views of one example of an embodiment of a method for manufacturing a display panel base material of the present invention. FIG. 5 is a schematic view for describing a method of evaluating the close adhesion strength of a retardation control layer.

In FIGS. 1 to 3, the numeral 10 represents a sheet-shaped base material; 11 is a base material (here, glass substrate); 12 is a black matrix layer; 12a is a black matrix frame; 13 is a color filter layer; 14 is a retardation control layer; 14a is an anisotropic phase part; 14b is an isotropic phase part; 17a is an image region; 17b is a seal region; 20 is a sheet-shaped base material (also referred to as opposing base material or opposing substrate); 30 is a seal material; 40 is a driving liquid crystal; 41 is a polarizing plate; 42 is a driving liquid crystal; 42a is an orientation state in the lateral direction; 43 is a positive C plate; 44 is a color filter part; 45 is a positive A plate; 46 is a polarizing plate; 51 is a sheet-shaped base material; 52 is a polymerizable liquid crystal; 53 is an ionizing radiation such as ultraviolet rays; 54 is an anisotropic phase part; 55a is an isotropic non-cured part; 55 is an isotropic phase part; 56 is a retardation control layer; 61 is a base material (here, glass substrate); 62 is a retardation control layer; 62a is an exfoliated retardation control layer; 63 is an adhesive agent; and 64 is a stud pin.

First, one example of an embodiment of a display panel base material of the present invention will be described with reference to FIG. 1.

The display panel base material of the present invention is a display panel base material used in a liquid crystal display panel of in-cell type and having a retardation control layer disposed on a surface thereof, where, on a sheet-shaped base material 10 in which a black matrix layer 12 and a color filter layer (also referred to as a colored layer) 13 are disposed on a transparent base material 11 in the order from the base material 11 side, there is laminated a retardation control layer 14 in which, using a polymerizable liquid crystal as a material, an anisotropic phase part 14a that generates a retardation when light is incident and an isotropic phase part 14b that does not generates a retardation when light is incident are arranged to be separated in a regional manner in a plane direction thereof. Here, “to be separated in a regional manner” represents that “a predetermined region is sectioned as a region corresponding to a specific region”. More specifically, the retardation control layer 14 is “separated in a regional manner” into an anisotropic phase part and an isotropic phase part by sectioning the retardation control layer 14 so that, with respect to the retardation control layer 14, a predetermined region of the retardation control layer 14 corresponds to the anisotropic phase part 14a and the other region corresponds to the isotropic phase part 14b as viewed in a plan view.

Then, the retardation control layer 14 is formed to be patterned so that the part of the retardation control layer 14 on the color filter 13 will be the anisotropic phase part 14a and the region 17b predetermined to be seal on the retardation control layer 14 will be the isotropic phase part 14b.

By doing so, the pixel region 17a of the retardation control layer 14 is the anisotropic phase part 14a that can exhibit the retardation function thereof (function of generating a retardation in light). Also, the region 17b predetermined to be seal on the retardation control layer 14 is the isotropic phase part 14b that has a higher close adhesiveness to the base material 11 of the sheet-shaped base material 10 than the anisotropic phase part 14a. Therefore, in the region 17b predetermined to be seal, a good close adhesiveness is obtained between the base material 11 of the sheet-shaped base material 10 and the retardation control layer 14, making exfoliation less liable to occur, whereby leakage of light caused by poor close adhesiveness and decrease in the rigidity of the liquid crystal cell are prevented.

Here, since the display panel base material of the present example has a color filter disposed therein, it is also referred to as a color filter substrate or a colored layer forming substrate.

The retardation control layer 14 is obtained by curing a polymerizable liquid crystal serving as a material. As the polymerizable liquid crystal serving as a material, one uses a liquid crystalline monomer such as a polymerizable liquid crystal monomer being capable of three-dimensionally crosslinking in a liquid crystal state and being capable of freezing the liquid crystal structure (retaining a predetermined liquid crystal state) by using a reactive group such as an unsaturated bond that is present in a molecular structure thereof. The details such as the material quality and the method of forming will be described in the description of the method for fabricating the display panel base material shown in FIG. 4. Also, the details of the transparent base material 11 will be described in the description of the method for fabricating the display panel base material shown in FIG. 4.

Also, in the present example, all the colored layers of the color filter layer 13 and the black matrix 12 are formed by using the pigment dispersion method; however, the method of forming the colored layers is not limited to this alone.

For the colored layers, in addition to those formed by the pigment dispersion method, one may use those in which each colored pattern layer is formed by the dyeing method, the electrodeposition method, the printing method, the ink jet method, or the like that is conventionally known in the art.

Hereafter, a method of forming each of the aforementioned colored pattern layers will be briefly described.

In the pigment dispersion method, a step of forming a photosensitive resin layer by dispersing a pigment on a substrate and patterning this to obtain a colored pattern layer of a single color is repeated to form a colored pattern layer of each color.

In the dyeing method, a step of applying a water-soluble polymer material which is a material for dyeing on a glass substrate and, after this is patterned into a desired shape through a photolithography method, immersing the obtained pattern into a dyeing bath to obtain a colored pattern is repeated to form a colored pattern layer of each color.

In the electrodeposition method, a step of patterning a transparent electrode on a substrate and immersing it into an electrodeposition application liquid containing a pigment, a resin, an electrolysis solution, and the like to electrodeposit a predetermined color is repeated to form a colored pattern layer of each color, and the resin is cured by heating.

In the printing method, a step of dispersing a pigment into a resin of thermal setting type and printing is repeated to paint each color separately, and then the resin is thermally cured to for each colored pattern layer, and the color filter layer 13 and the black matrix 12 are formed in the respective colored pattern layers, and the whole of the respective colored pattern layers form a colored layer.

In the ink jet method, a liquid containing a coloring agent (hereafter referred to as an ink or a paste) is jetted from an opening such as a nozzle or an orifice to form a color filter layer. Namely, by the ink jet method, an ink or a paste containing a coloring agent forms each colored pattern layer, and the whole of the respective colored pattern layers form a colored layer, and this colored layer constitutes a color filter part.

Next, one example of a method of manufacturing a display panel base material of the present example will be described.

The method of manufacturing a display panel base material of the present example is briefly such that a sheet-shaped base material in a state in which a black matrix layer 12 and a color filter layer 13 are laminated in this order on a base material 11 (in a state in which the retardation control layer is absent in the display panel base material of the present example shown in FIG. 1) is prepared, and the steps of (a) applying an application liquid containing a polymerizable liquid crystal on a sheet-shaped base material to form a coating film, (b) orienting the polymerizable liquid crystal of the coating film to allow the coating film to have anisotropy, (c) selectively radiating an ionizing radiation such as ultraviolet rays onto the coating film allowed to have anisotropy, so as to polymerize and cure the polymerizable liquid crystal only at a part radiated with the ionizing radiation, so as to form an anisotropic phase part, and (d) heating the sheet-shaped base material on which the coating film having the anisotropic phase part is formed, so as to allow a non-cured part of the coating film to undergo phase transition to make the part isotropic, and polymerizing and curing the non-cured part in that state to form an isotropic part are carried out. Here, the ionizing radiation is assumed to refer to a general concept of electromagnetic waves such as light beams capable of exciting a polymerizable functional group in a molecular structure of a predetermined compound and, specifically, one can mention electron beams in addition to the above-described ultraviolet rays as an example.

Hereafter, the method of fabricating a display panel base material of the present example will be described in detail with reference to FIG. 4.

In advance, a sheet-shaped base material in which a black matrix layer and a color filter layer are laminated in this order on a base material in a state in which the retardation control layer 14 is absent in the display panel base material of the present example shown in FIG. 1 is prepared.

Here, the total colored layers of the black matrix layer 12 and the color filter layer 13 are formed on the base material 11 by the pigment dispersion method; however, the present invention is not limited thereto.

Here, the forming of the colored layers by the pigment dispersion method and the forming by other methods are general, so that a detailed description thereof will be omitted.

Here, in the present specification, it is assumed that “to laminate a black matrix layer and a color filter layer in this order on a base material” means “to form a black matrix layer on a base material of the aforethe sheet base material, and to form a color filter layer at least in a space part of the black matrix layer”, and that “to laminate a black matrix layer, a color filter layer, and a retardation control layer in this order on a base material” means “to form a black matrix layer on a base material of the aforethe sheet base material, to form a color filter layer at least in a space part of the black matrix layer, and to laminate the aforethe retardation control layer on the color filter layer”. Here, the space part of the black matrix layer is assumed to be a gap part that is formed in a predetermined region in a plan view in accordance with the formed pattern of the black matrix layer when the black matrix is patterned on the base material.

Subsequently, each of the following steps is sequentially carried out.

Each step will be described with reference to FIG. 4.

### (1) Step of Forming the Anisotropic Phase Part 54 (Anisotropic Phase Part 14a in FIG. 1)

First, an application liquid containing a liquid crystal material such as a polymerizable liquid crystal monomer is applied on a base material, so as to form a coating film. (FIG. 4(a)) A polymerizable chiral agent may be added to the application liquid in accordance with the anisotropy demanded in the retardation control layer.

As the application method, a known technique can be used.

Specifically, the application liquid can be applied onto the substrate by the roll coating method, the gravure coating method, the slide coating method, the immersion method, or the like.

Next, the coating film formed on the sheet-shaped base material 51 is oriented by being held at a predetermined temperature at which the polymerizable liquid crystal 52 exhibits a liquid crystal structure. In a state in which the polymerizable liquid crystal 52 is allowed to exhibit the liquid crystal structure in the coating film (which is also referred to as a liquid crystal phase state), an ionizing radiation 53 such as ultraviolet rays is selectively radiated onto the coating film for exposure, so as to polymerize and cure the polymerizable liquid crystal, thereby to obtain an anisotropic phase part 54 (FIGS. 4(b) to 4(c)).

Through this step, the anisotropic phase part 54 is formed at a desired position.

The part not radiated by the ionizing radiation is in a state in which the liquid crystal material is not solidified (liquid crystal phase).

As a method of selectively radiating an ionizing radiation 53 such as ultraviolet rays onto the coating film in a product (referred to as a base body) in which the coating film is formed on the sheet-shaped base material 51, a method of using a photomask patterned to have a predetermined pattern and radiating an ionizing radiation onto the coating film through the intermediary of the photomask is typically adopted. Because of being a method capable of easily carrying out patterning into a fine pattern, this method is preferably used in the case in which an anisotropic phase part 54 is formed in a fine pattern in a pixel region in a liquid crystal display panel base material.

However, as a method of selectively radiating an ionizing radiation 53 such as ultraviolet rays onto the coating film, besides the above-described method using a photomask, it is preferable that a metal mask is used in place of the photomask in carrying out the above-described photolithography method in view of the fact that common defects are not observed in the pixel region and in view of being less expensive.

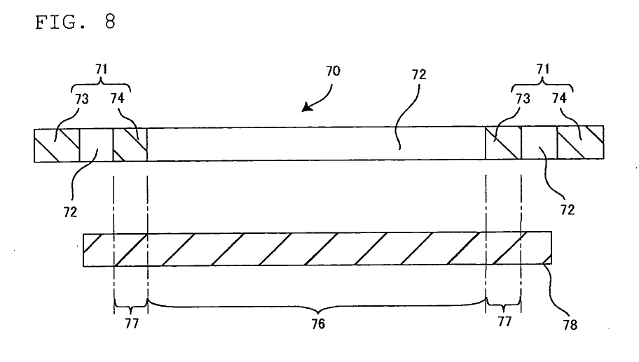

As shown in FIG. 7(a), in a plan view, a metal mask 70 is made of a light-transmitting part 72 capable of transmitting light and a light-shielding part 72 that shields against passage of light. The light-shielding part 72 has a frame-shaped outer frame 73 and further is made by disposing a part having a predetermined shape (a frame part 74 formed to have a frame shape having a small width in the example of FIG. 7(a)) within the frame-shaped outer frame 73 (the region surrounded by the outer frame 73). In this metal mask 70, as shown in FIG. 8, the shape and the region of the inside frame part 74 correspond to the shape and the region of the region 77 predetermined to be seal on the base body 78, and the shape and the region further inside the shape of the inside frame part 74 correspond to the shape and the region of the region 76 allotted to pixel of the base body 78. Also, the region corresponding to the fringe part of the base body 78 is located between the inside frame part 74 and the outer frame 73.

The shape of the metal mask 70 is ideally a shape such that the frame-shaped outer frame 73 and the inside frame part 74 are separated as shown in FIG. 7(a). However, as viewed in a natural science manner, it cannot assume a shape such that the frame-shaped outer frame 73 and the inside frame part 74 are separated, so that it must be provided with a connection part 75 that connects between the frame-shaped outer frame 73 and the inside frame part 74 as shown in FIGS. 7(b) and 7(c). Regarding the connection part 75, the position, the shape, and the size of the part that connects between the frame-shaped outer frame 73 and the inside frame part 74 is not particularly limited as long as it can connect between the frame-shaped outer frame 73 and the inside frame part 74 with a sufficient strength. However, the connection part 75 is preferably as small as possible in view of the fear of line contamination in the production steps and the facility in handling.

As a method of curing the coating film while maintaining the liquid crystal in a liquid crystal phase state, in the case of using the three-dimensional cross-linking method, the coating film is cured with ultraviolet ray radiation, for example, by adding a photopolymerization initiator to the liquid crystal molecule.

Also, as a method of curing the coating film, one can employ a method of curing by radiating electron beams.

In the case of using ultraviolet rays as the ionizing radiation, it is preferable that the amount of exposure is generally about 200 mJ/cm², and the exposure wavelength is preferably about 200 to 450 nm.

Also, in the case of exposing with use of electron beams, it is preferably about 50 to 500 Gy.

### (2) Step of Forming the Isotropic Phase Part 55 (Anisotropic Phase Part 14b in FIG. 1)

Next, as shown in FIG. 4(c), the part that has not been radiated with the ionizing radiation 53 such as ultraviolet rays, namely, the part (liquid crystal phase) in which the polymerizable liquid crystal 52 has not been cured is heated to or above the temperature at which it undergoes transition to the isotropic phase (hereafter referred to as isotropic phase transition temperature).

At or above the isotropic phase transition temperature, the uncured polymerizable liquid crystal 52 undergoes transition to the isotropic phase, and loses the liquid crystal orientation.

Here, the isotropic phase transition temperature can be measured by a measuring apparatus such as DSC.

Also, in the phase transition from the liquid crystal phase to the isotropic phase, the isotropic phase transition temperature can be confirmed generally by a polarization microscope observation as well.

On the other hand, in the liquid crystal layer part (the anisotropic phase part) that has been cured by radiation of ionizing radiation such as ultraviolet rays in the previous step, the liquid crystal order orientation will not be disturbed even if heated above the isotropic phase transition temperature because the liquid crystal molecule is fixed by polymerization.

Subsequently, from the uncured state (FIG. 4(d)), the coating film is further heated to polymerize and cure the uncured polymerizable liquid crystal 55a which is in an isotropic phase, thereby to obtain a cured isotropic phase part 55.

In this manner, by curing the whole part of the polymerizable liquid crystal that has been applied onto the sheet-shaped base material 51, a display panel base material (FIG. 4(e)) is obtained having a retardation control layer 56 in which a cured anisotropic phase part 54 that generates a retardation when light is incident and an isotropic phase part 55 that does not generate a retardation even when light is incident are patterned into a desired shape.

Each of the materials used in the method of manufacturing the display panel base material of the present example shown in FIG. 4 will be further described.

As the polymerizable liquid crystal monomer used for forming the retardation control layer 56 (corresponding to the layer denoted by the reference numeral 14 in FIG. 1), one can use, for example, those disclosed in Japanese Patent Application Laid-Open No. 10-508882 and, as the polymerizable chiral agent, one can use, for example, those disclosed in Japanese Patent Application Laid-Open No. 7-258638. More specifically, as the polymerizable liquid crystal monomer, those represented by the following formulas (1) to (11) can be exemplified and, as the polymerizable chiral agent, those represented by the following formulas (12) to (14) can be exemplified.

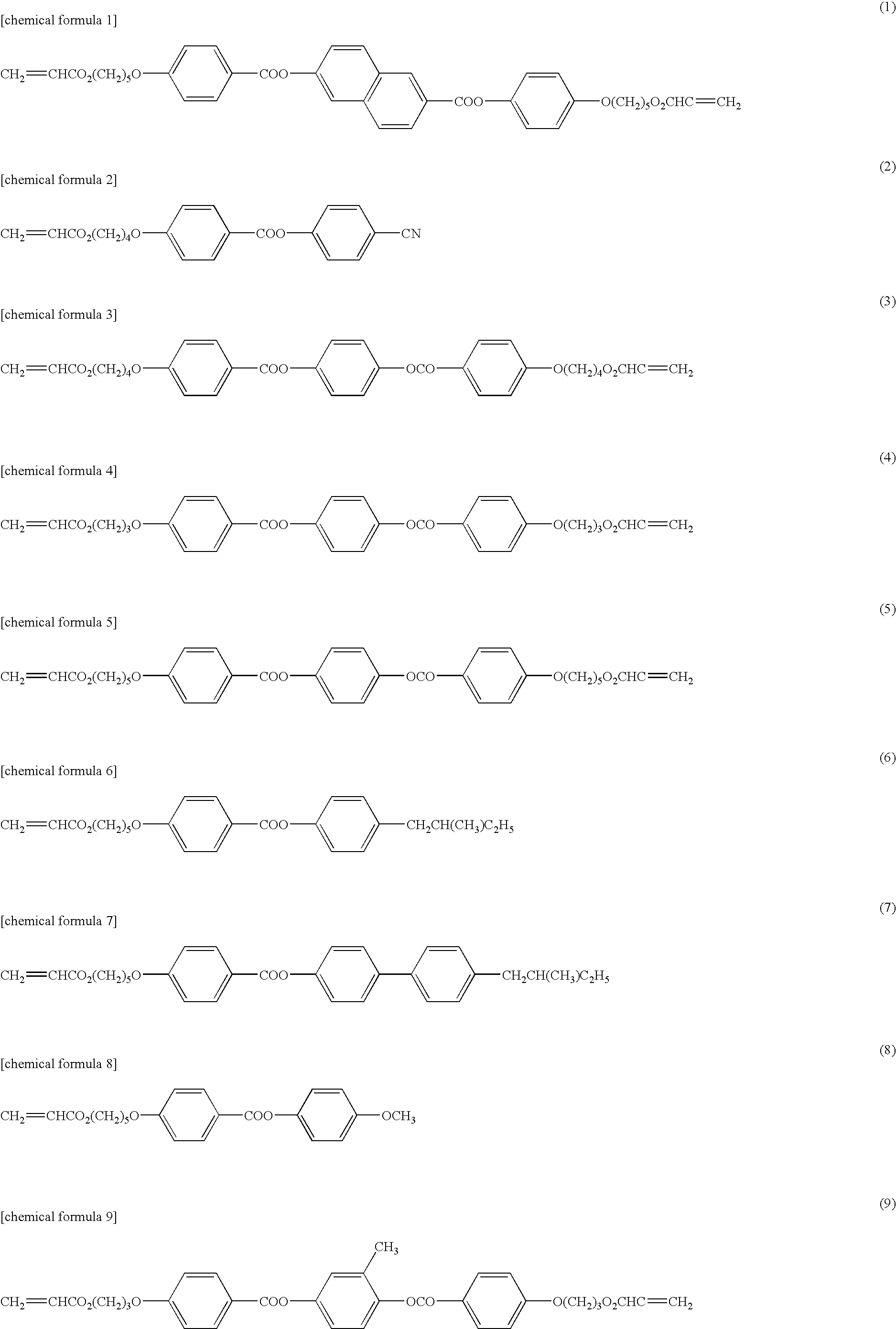

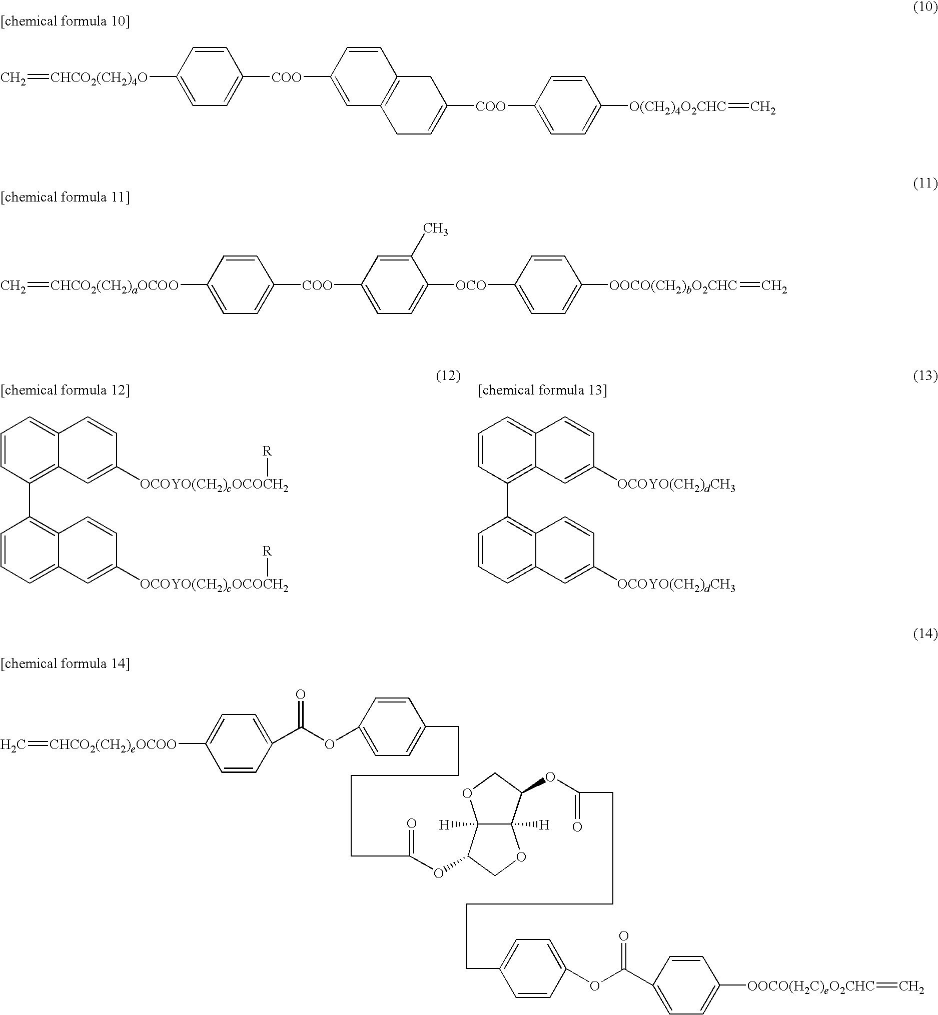

In the representation of each of the above formulas, a to e each denoting the number of methylene groups (the chain length of the alkylene groups) in the [chemical formula 11] to [chemical formula 14] are all integers. First, a and b are each individually 2 to 12, more preferably 4 to 10, still more preferably 6 to 9; c and d are each 2 to 12, more preferably 4 to 10, still more preferably 6 to 9; and further e is 2 to 5.

A silane coupling agent may be blended into the composition such as the application liquid used for forming the aforethe retardation control layer 56 (corresponding to the layer denoted with the reference numeral 14 in FIG. 1).

As the silane coupling agent, those having a hydrophilic functional group such as amine or those having a ketimine structure are preferable, and it is preferably soluble into an organic solvent in preparing the composition for forming the retardation control layer 56. From among those mentioned later, one kind or two or more kinds can be used. The amount of blending thereof is preferably about 0.001% to 10% (mass standard), more preferably about 0.01% to 5% to the liquid crystal material, of a degree that does not inhibit the orientation of the liquid crystal.

As a specific silane coupling agent, it is exemplified as an agent selected from;
N-2(aminoethyl)-3-aminopropylmethyldimethoxysilane (manufactured by Shin-Etsu Chemical Co., Ltd., Shinetsu Silicone “KBM-602”),
N-2(aminoethyl)-3-aminopropyltrimethoxysilane (manufactured by Shin-Etsu Chemical Co., Ltd., Shinetsu Silicone “KBM-603”),
3-aminopropyltrimethoxysilane (manufactured by Shin-Etsu Chemical Co., Ltd., Shinetsu Silicone “KBM-903”),
γ-aminopropyltriethoxysilane (manufactured by GE Toshiba Silicone Co., Ltd., “TSL-8331”),
N—(β-aminoethyl)-γ-aminopropyltrimethoxysilane (manufactured by GE Toshiba Silicone Co., Ltd., “TSL-8340”),
N-(β-aminoethyl)-γ-aminopropylmethyldimethoxysilane (manufactured by GE Toshiba Silicone Co., Ltd., “TSL-8345”),
γ-(2-aminoethyl)aminopropyltrimethoxysilane (manufactured by Dow Corning Co., Ltd., “SH-6020”),
γ-(2-aminoethyl)aminopropylmethyldimethoxysilane (manufactured by Dow Corning Co., Ltd., “SH-6023”), and others.

Also, in the composition such as described above, it is preferable to blend an optical polymerization initiator within a range that does not deteriorate the orientation of the liquid crystal, and in particular a radical polymerization initiator that generates a free radical by ultraviolet radiation is preferable.

The amount of blending the optical polymerization initiator is preferably about 0.01% to 15% (mass standard), more preferably about 0.5% to 10% to the liquid crystal material.

As a specific optical polymerization initiator, it is exemplified as an initiator selected from; benzyl (also referred to as bibenzoyl), benzoin isobutyl ether, benzoin isopropyl ether, benzophenone, benzoylbenzoic acid, methyl benzoylbenzoate, 4-benzoyl-4′-methyldiphenyl sulfide, benzylmethylketal, dimethylaminomethyl benzoate, 2-n-butoxyethyl-4-dimethylaminobenzoate, isoamyl p-dimethylaminobenzoate, 3,3′-dimethyl-4-methoxybenzophenone, methylobenzoyl formate, 2-methyl-1-(4-(methylthio)phenyl)-2-morpholinopropane-1-one, 2-benzyl-2-dimethyamino-1-(4-morpholinophenyl)-butane-1-one, 1-(4-dodecylphenyl)-2-hydroxy-2-methylpropane-1-one, 1-hydroxycyclohexylphenylketone, 2-hydroxy-2-methyl-1-phenylpropane-1-one, 1-(4-isopropylphenyl)-2-hydroxy-2-methylpropane-1-one, 2-chlorothioxanthone, 2,4-diethylthioxanthone, 2,4-diisopropylthioxanthone, 2,4-dimethylthioxanthone, isopropylthioxanthone, 1-chloro-4-propoxythioxanthone, and others.

The base material (denoted with the reference numeral 11 in FIG. 1) is preferably constructed with an inorganic base material such as glass, silicon, or quartz; however, it can be constructed with an organic base material such as mentioned below.

The organic base material is made of a raw material exemplified as acrylic polymer such as polymethyl methacrylate, polyamide, polyacetal, polybutylene terephthalate, polyethylene terephthalate, polyethylene naphthalate, triacetylcellulose, or syndiotactic polystyrene or the like, polyphenylene sulfide, polyetherketone, polyetheretherketone, fluororesin, or polyethernitrile or the like, polycarbonate, denatured polyphenyleneether, polycyclohexene, or polynorbornene series resin or the like, or polysulfone, polyethersulfone, polyallylate, polyamideimide, polyetherimide, or thermoplastic polyimide or the like; however, those made of a general plastic can be used as well.

The thickness of the base material is not particularly limited; however, those having a thickness of, for example, about 5 μm to several mm are used in accordance with the intended usage.

The black matrix (denoted with the reference numeral 12 in FIG. 1) is formed here by using a photosensitive resin composition of a paint type containing a black coloring agent and performing application, pattern-shaped exposure, and development; however, a resin composition containing a black coloring agent may be applied onto one surface of the object surface and, after temporary solidification, a photoresist may be applied to form a predetermined pattern.

The thickness of the black matrix is about 0.5 μm to 2 μm.

The construction of the fine region of each color constituting the color filter layer may be formed by disposing a colored pattern layer of each color for each opening part of the black matrix layer; however, in a convenient manner, it may be formed by disposing a colored pattern layer band like as to each color.

The color filter layer is constructed with a resin composition in which a coloring agent is dissolved or dispersed, preferably a fine pigment is dispersed, and it may be formed by preparing an ink composition colored to a predetermined color and printing the ink composition to form a pattern corresponding to the colored pattern of each color; however, it is preferably formed by the photolithography method using a photoreceptive resin composition of a paint type containing a coloring agent of a predetermined color. The thickness of the color filter layer is about 1 μm to 5 μm.

The display panel base material of the present invention is used in an in-cell type display panel in the manner shown in FIG. 2.

The display panel shown in FIG. 2 is a in-cell type liquid crystal display panel in which a display panel base material 10 and an opposing base material 20 shown in the above FIG. 1 are bonded through the intermediary of a sealing material 30 in a seal region 17b of the display panel base material while keeping a constant gap, and the inside thereof is filled with a liquid crystal 40 and tightly sealed, and is a liquid crystal panel of horizontal orientation mode (IPS mode).

A schematic perspective view showing the construction of the display panel of the present example in explosion will be, for example, like FIG. 3 in the case of the horizontal orientation mode (IPS mode). This display panel includes the retardation control layer 14 of FIG. 1 as a positive C plate 43, and also includes a positive A plate 45. In particular, by using the display panel base material 10 of the present example shown in FIG. 1, a good close adhesiveness in the seal region 17b of the retardation control layer 14 is obtained, thereby effectively preventing leakage of light caused by poor close adhesiveness.

Here, in FIG. 2, in each base material, an electrode part, a switching element part, and others are disposed in the base material; however, illustration thereof is omitted. In FIG. 3, illustration of the base material and the like of the display panel base material 10 and the opposing base material 20 shown in FIG. 1 is omitted.

Also, the two arrows of the polarizing plates 41, 46 of FIG. 3 show directions of the absorption axes.

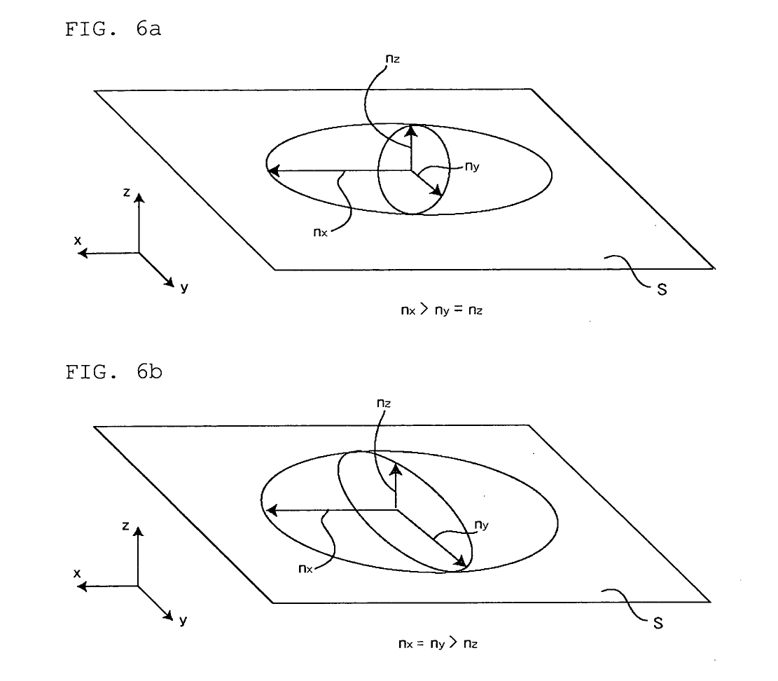

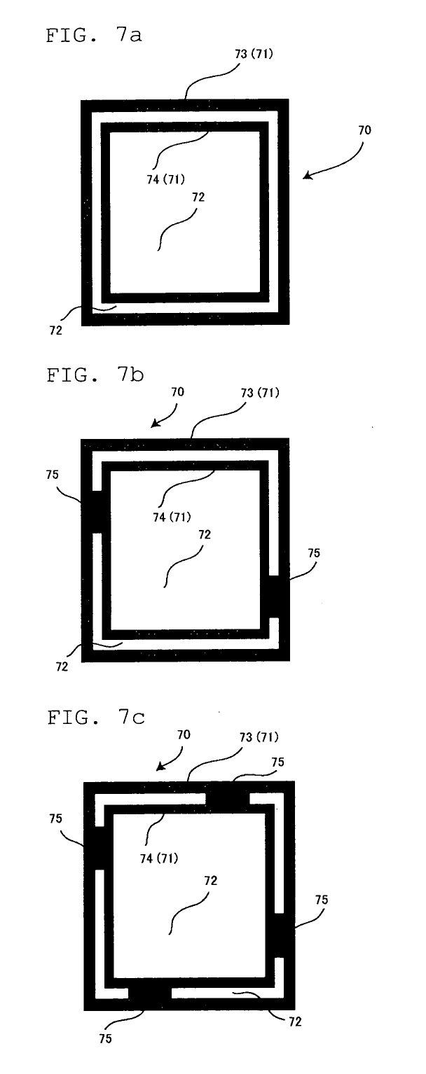

Here, the retardation control layer is one referred to as a positive C plate. In this retardation control layer, assuming that the layer surface of the retardation control layer is the S plane shown in FIG. 6(a) or FIG. 6(b), the anisotropic phase part of the retardation control layer having a relationship of nₓ=n_{y}<n_{z} constitutes a retardation layer having an optically positive monoaxial property in the normal line direction of the S surface. This case is referred to as being a case in which the retardation control layer is a positive C plate.

As the liquid crystal 22 (denoted with the reference numeral 40 in FIG. 3), a conventionally known horizontal orientation liquid crystal (also referred to as IPS liquid crystal) is used.

The sealing material (denoted with the reference numeral 30 in FIG. 2) may be any one as long as it is one that is conventionally used in a liquid crystal display panel and, for example, a resin sealing material having resin as a source material is used.

As the resin sealing material, one kind or two or more kinds of bisphenol-F type, bisphenol-A type diglycidyl ether, resorcinol diglycidyl ether resin, phenol novolak type epoxy resin, or triphenolmethane type epoxy resin are used and, specifically, a sealing material XN-5A manufactured by Mitsui Chemical Co., Ltd. and the like are used, for example.

This sealing material may contain other components of resin sealing agents in accordance with the needs.

As the other components, it is exemplified as a component selected from; fine particles of carbon black, resin-covering type carbon black, iron oxide, titanium oxide, aniline black, cyanine black, and the like, inorganic fillers such as talc and mica, silane coupling agents such as aminosilane and epoxysilane, solvents such as cellosolve and carbitols, curing promoters such as imidazoles, triphenylphosphinebicycloundecene, trisdimethylaminomethylphenol, and the like.

Illustration of each of the other parts will be omitted by making reference to the description of each part of the display panel base material 10 shown in FIG. 1 instead.

Here, as a display panel using the display panel base material 10, a liquid crystal display panel of in-cell type and of horizontal orientation mode (IPS mode) has been mentioned as one example; however, the present invention is not necessarily limited to this alone.

In a liquid crystal display panel of vertical orientation mode (also referred to as VA mode), in order to reduce the viewing-angle-dependency thereof, a retardation film having an optical axis perpendicular to the substrate and having a negative birefringence anisotropy (which is also referred to as a negative C plate) and a retardation film having an optical axis horizontal to the substrate and having a positive birefringence anisotropy (which is also referred to as a positive A plate) are used in combination. For example, the negative C plate may be formed with those obtained by adding a chiral agent to the composition constituting the positive A plate, and the positive A plate is formed by disposing an orientation film (optical orientation film or rubbing film) on a polymerizable liquid crystal.

Hereafter, Examples of the display panel base material 10 of the present example will be raised, and also the Comparative Examples will be raised in order to show that the case of disposing an isotropic phase part 14b in the region predetermined to be sealed is more excellent in the close adhesiveness between the retardation control layer and the base material 11 in the region predetermined to be sealed than the case of disposing an anisotropic phase part 14a in the region predetermined to be sealed

### EXAMPLES

### Example 1

A sheet-shaped base material in a state in which the retardation control layer 14 was not formed in the display panel base material 10 of the present example and in which a black matrix layer 12 and a color filter layer 13 were disposed on one surface of a glass base material serving as a base material 11 was formed by using a colored resist of each color prepared respectively in the following manner and forming a patterned colored layer (also referred to as a colored pixel pattern) on one surface side of the base material by the photolithography method.

### (Preparation of Colored Resist)

A pigment dispersion type photoresist was used for the black matrix and the coloring material of the red (R), green (G), and blue (B) colored pixels. The red (R), green (G), and blue (B) colored pixels constitute a color filter layer.

The pigment dispersion type photoresist is one obtained by using a pigment as a coloring material, adding beads into a dispersion liquid composition (containing a pigment, a dispersing agent, and a solvent), dispersing the resultant in a dispersing apparatus for three hours, and thereafter mixing the dispersion liquid from which the beads have been removed and a clear resist composition (containing a polymer, a monomer, an additive, an initiator, and a solvent).

The composition thereof is shown below.

Here, as the dispersing apparatus, a Paint Shaker (manufactured by Asada Iron Industry Co., Ltd.) was used.

### (Photoresist for Black Matrix)

black pigment . . . 14.0 parts by weight

(TM Black #9550 manufactured by Dainichiseika Color & Chemicals Mtg. Co., Ltd.)

dispersing agent . . . 1.2 parts by weight

(Disperbyk 111 manufactured by BYK Japan KK)

polymer . . . 2.8 parts by weight

(VR60 manufactured by SHOWA HIGHPOLYMER CO., LTD.)

monomer . . . 3.5 parts by weight

(SR399 manufactured by Thertomer Co., Ltd.)

additive . . . 0.7 part by weight

(L-20 manufactured by Soken Chemical & Engineering Co., Ltd.)

initiator . . . 1.6 parts by weight

(2-benzyl-2-dimethylamino-1-(4-morpholinophenyl)-butanone-1)

initiator . . . 0.3 part by weight

(4,4′-diethylaminobenzophenone)

initiator . . . 0.1 part by weight

(2,4-diethylthioxanthone)

solvent . . . 75.8 parts by weight

### (Ethylene Glycol Monobutylether)

### (Photoresist for Red (R) Colored Pixel)

red pigment . . . 4.8 parts by weight

(C.I.PR254 (chromophthal DPP Red BP manufactured by Chiba Specialty Chemicals Co., Ltd.))

yellow pigment . . . 1.2 part by weight

(C.I.PY139 (Palliotol Yellow D1819 manufactured by BASF Co., Ltd.))

dispersing agent . . . 3.0 parts by weight

(Solsparce 24000 manufactured by Zeneka Co., Ltd.)

monomer . . . 4.0 parts by weight

(SR399 manufactured by Thertomer Co., Ltd.)

polymer 1 . . . 5.0 parts by weight

initiator . . . 1.4 parts by weight

(Irgacure 907 manufactured by Chiba-Geigy K.K.)

initiator . . . 0.6 part by weight

(2,2′-bis(o-chlorophenyl)-4,5,4′,5′-tetraphenyl-1,2′-biimidazole)

solvent . . . 80.0 parts by weight

### (Propylene Glycol Monomethylether Acetate)

### (Photoresist for Green (G) Colored Pixel)

green pigment . . . 3.7 parts by weight

(C.I.PG7 (Seika Fast Green 5316P manufactured by Dainichiseika Color & Chemicals Mtg. Co., Ltd.))

yellow pigment . . . 2.3 part by weight

(C.I.PY139 (Palliotol Yellow D1819 manufactured by BASF Co., Ltd.))

dispersing agent . . . 3.0 parts by weight

(Solsparce 24000 manufactured by Zeneka Co., Ltd.)

monomer . . . 4.0 parts by weight

(SR399 manufactured by Thertomer Co., Ltd.)

polymer 1 . . . 5.0 parts by weight

initiator . . . 1.4 parts by weight

(Irgacure 907 manufactured by Chiba-Geigy K.K.)

initiator . . . 0.6 part by weight

(2,2′-bis(o-chlorophenyl)-4,5,4′,5′-tetraphenyl-1,2′-biimidazole)

solvent . . . 80.0 parts by weight

### (Propylene Glycol Monomethylether Acetate)

### (Photoresist for Blue (B) Colored Pixel)

blue pigment . . . 4.6 parts by weight

(C.I.PB15:6 (Heliogen Blue L6700F manufactured by BASF Co., Ltd.))

purple pigment . . . 1.4 parts by weight

(C.I.PV23 (Fostaperm RL-NF manufactured by Clariant Co., Ltd.))

pigment derivative . . . 0.6 part by weight

(Solsparce 12000 manufactured by Zeneka Co., Ltd.)

dispersing agent . . . 2.4 parts by weight

(Solsparce 24000 manufactured by Zeneka Co., Ltd.)

monomer . . . 4.0 parts by weight

(SR399 manufactured by Thertomer Co., Ltd.)

polymer 1 . . . 5.0 parts by weight

initiator . . . 1.4 parts by weight

(Irgacure 907 manufactured by Chiba-Geigy K.K.)

initiator . . . 0.6 part by weight

(2,2′-bis(o-chlorophenyl)-4,5,4′,5′-tetraphenyl-1,2′-biimidazole)

solvent . . . 80.0 parts by weight

### (Propylene Glycol Monomethylether Acetate)

### (Forming a Colored Pixel Pattern)

A low-expansion-ratio non-alkali glass plate (1737 glass manufactured by Corning Incorporated having a size of 100 mm×100 mm and a thickness of 0.7 mm) was prepared as a base material 11 subjected to a suitable washing operation to be clean.

In order to form the above-described colored layer, the photoresist for a black matrix prepared in the above (hereafter also denoted as photoresist for BM) was applied to a thickness of 1.2 μm by the spin coating method on the top surface of the glass substrate which will be the base material 11 washed in the previous step, and it was prebaked under a condition of 80° C. for 3 minutes, and exposed to light (100 mJ/cm²) with use of a mask formed into a predetermined pattern. Subsequently, after performing spray development using a 0.05% aqueous solution of KOH for 50 seconds, it was postbaked at 230° C. for 30 minutes to fabricate a BM substrate.

Next, the pigment dispersion type photoresist of the red color (R) was applied onto the above BM substrate by the spin coating method, and it was prebaked under a condition of 90° C. for 3 minutes, and was subjected to alignment exposure to light (100 mJ/cm²) with use of a mask formed into a predetermined pattern. Subsequently, after performing spray development using a 0.1% aqueous solution of KOH for 50 seconds, it was postbaked at 230° C. for 30 minutes to form a red (R) colored pixel pattern having a film thickness of 1.2 μm at a predetermined position relative to the BM pattern.

Subsequently, a green (G) colored pixel pattern having a film thickness of 1.2 μm was formed by the same method and under the same condition as in the method of forming the above-described red (R) colored pixel pattern.

Further, a blue (B) colored pixel pattern having a film thickness of 1.2 μm was formed by the same method and under the same condition as in the method of forming the above-described red (R) colored pixel pattern.

By the above, a colored layer constructed with the BM, the red colored pixel, the green colored pixel, and the blue colored pixel was formed on the substrate.

In the above manner, after formation of a sheet-shaped base material in which the black matrix layer 12 and the color filter layer 13 were disposed on one surface of the base material 11, an application liquid having the following composition (photosensitive resin composition for forming the retardation control layer 14) was applied on one surface of the sheet-shaped base material, so as to form a coating film.

### <Method of Fabrication and Materials>

### (Photosensitive Resin Composition for Forming the Retardation Control Layer 14)

polymerizable liquid crystal monomer . . . 22 parts
(the one shown in “chemical formula 11” and exhibiting the nematic liquid crystal phase)
polymerizable chiral agent (the one shown in “chemical formula 14” . . . 1.8 parts
photopolymerization initiator . . . 1.3 parts
(Irgacure 907 manufactured by Chiba Specialty Chemicals Co., Ltd.)
amine series silane coupling agent . . . 0.05 part
(TSL-8331 manufactured by GE Toshiba Silicone Co., Ltd.)
solvent (chlorobenzene) . . . 75 parts

Next, by holding the afore the base material at 80° C. for 3 minutes, a liquid crystal phase state was provided in which the polymerizable liquid crystal 52 was oriented.

The phase transition to the liquid crystal phase was confirmed by the change of the coating film from white turbidity to transparency.

In that state, with use of a metal mask having a structure such that another frame-shaped frame part is formed in the inside of a frame-shaped outer frame and having a construction such that the outer frame and the inside frame part are connected at a predetermined position, ultraviolet rays were radiated towards the coating film through the intermediary of this metal mask by the ultraviolet ray radiation apparatus. Here, in the metal mask, the inside frame part is formed to have a width dimension being capable of covering the region of the region predetermined to be sealed and not penetrating into the pixel region. The metal mask was disposed so that the region predetermined to be sealed on the coating film was shielded against light by the inside frame part.

Also, the amount of radiation of the ultraviolet rays radiated towards the coating film was set to be 20 mW/cm²×5 seconds.

By this, in the coating film, the part radiated with ultraviolet rays was cured by being cross-linked in a three dimensional manner, and the part shielded against light remained to be an uncured polymerizable liquid crystal (anisotropic).

Subsequently, the glass base material on which the coating film was formed was held at 230° C. for 30 minutes to change the uncured polymerizable liquid crystal (anisotropic) to be isotropic.

At this time, the part radiated with ultraviolet rays is not denatured because it is already cured as it is in an oriented state.

Thereafter, the plate base material on which the coating film was formed was held at 230° C. for 30 minutes to thermally cure the isotropic part to obtain an isotropic phase part, thereby to obtain a display panel base material 10 provided with a retardation control layer having an anisotropic phase part and an isotropic phase part.

As a method of evaluating the close adhesion strength of the isotropic phase part 14b of the retardation control layer 14 of the obtained display panel base material 10, a Sebastian exfoliation testing method was adopted.

The Sebastian exfoliation testing method is a method in which a predetermined jig is bonded onto the layer surface as shown in FIG. 5(a), and a force is measured at the time of being peeled off by performing a tensile test in the up-and-down direction.

Specifically, on the surface of the isotropic phase part 14b of the retardation control layer 14 (denoted by the reference numeral 62 in FIG. 5(a)) of the obtained display panel base material 10 (denoted by the reference numeral 61 in FIG. 5(a)) fabricated in the above-described manner, a stud pin (the reference numeral 64 in FIG. 5(b)) having a diameter of 2 to 3 mmΦ was bonded with use of an adhesive agent, so as to obtain a structure in which the retardation control layer 62 and the stud pin 64 were bonded through the intermediary of an adhesive layer 63 formed by the adhesive agent. At this time, as the adhesive agent, a sealing material (XN-21-S: trade name manufactured by Mitsui Chemical Co., Ltd.) 30 was used. Then, with use of the structure, a tensile test was carried out in a strength tester of Sebastian V type manufactured by QUAD GROUP Co., Ltd., Romulus IV.

The exfoliation state of the stud pin 64 after the exfoliation was determined by eye inspection. When exfoliation was generated between the base material 61 and the retardation control layer 62 as shown in FIG. 5(c), it was determined as being “poor”, whereas when exfoliation was generated only in the area between the adhesive agent 63 and the stud pin 64 as shown in FIG. 5(b), it was determined as being “good”, thereby to evaluate the close adhesion strength between the isotropic phase part (denoted by the reference numeral 14b in FIG. 1) of the retardation control layer 62 and the base material 61.

The ratio of the “poor” is referred to as an exfoliation ratio (%).

As a pre-process of the evaluation test, after the stud pin 64 was bonded to the base material 61 having the aforethe retardation control layer 62 disposed thereon with use of the aforethe sealing material as an adhesive agent constituting the adhesive layer 63, it was put into a vat filled with pure water and kept under a condition of 121° C. and a humidity of 100%.

Thereafter, after being cooled by air and natural drying, the Sebastian exfoliation test was carried out.

The result of the Sebastian exfoliation test of the base material 61 having the aforethe retardation control layer 62 disposed thereon is shown below.

The number of samples was 10, and all of them were “good”. The exfoliation ratio was 0%.

### COMPARATIVE EXAMPLE 1

The Comparative Example of the display panel base material 10 of the present example is such that the whole region including the region predetermined to be sealed is set to be an anisotropic phase part.

In the same manner as in the Example 1, after formation of a sheet-shaped base material which is a sheet-shaped base material in a state that the retardation control layer 14 is not formed in a display panel base material 10 of the present example and disposes a black matrix layer 12 and a color filter layer 13 on one surface of a base material 11 on one surface of a base material 11, an application liquid having the same composition as in the case of the Example 1 was applied in the same manner on one surface of the sheet-shaped base material, so as to form a coating film, and the polymerizable liquid crystal was brought into a liquid crystal state by being kept at 80° C. for 3 minutes.

Next, ultraviolet rays were radiated on the whole surface of the coating film without the intermediary of the metal mask.

While maintaining the liquid crystal state, the coating film was cross-linked in a three-dimensional manner, and was oriented in the whole area, whereby the whole region of the coating film became an anisotropic phase part.

Thereafter, the base material was kept at 230° C. for 30 minutes, thereby to obtain a display panel base material for the Comparative Example provided with a retardation control layer 14 whose whole surface is made of the anisotropic phase part 14a.

Evaluation similar to that of the Example 1 was carried out with use of the obtained display panel base material for the Comparative Example. The number of samples was 10, and the number of samples having a “good” evaluation was two.

The exfoliation ratio was 80%.

An average of the force when being peeled off was 159 kg/cm².

Here, the anisotropic phase part of the retardation control layer is cured by being polymerized while maintaining the state in which the polymerizable liquid crystal is oriented, and the isotropic phase part of the retardation control layer is cured by being polymerized while maintaining the state in which the polymerizable liquid crystal is not oriented. Therefore, one of the reasons why the close adhesiveness to the base material of the sheet-shaped base material in the region predetermined to be sealed is improved when an isotropic phase part is disposed in the region predetermined to be sealed on the retardation control layer as compared with the case in which an anisotropic phase part is disposed in the region predetermined to be sealed seems to be that, when an isotropic phase part is disposed in the region predetermined to be sealed, the number of functional groups to the base material is more in the region predetermined to be sealed than in the case when an anisotropic phase part is disposed in the region predetermined to be sealed.

### INDUSTRIAL APPLICABILITY

The display panel base material of the present invention makes it possible to provide a display panel base material for manufacturing a display panel having a retardation layer disposed in the inside of a cell and being capable of improving the close adhesiveness between the retardation layer in the seal region and the base material of the liquid crystal display panel substrate constituting the liquid crystal cell, whereby leakage of light can be prevented, and the rigidity of the liquid crystal cell can be improved.

1. A display panel base material used in a display panel of in-cell type and having a retardation control layer disposed on a surface thereof, wherein,
on a sheet-shaped base material, there is laminated the retardation control layer using the polymerizable liquid crystal as a material in which an anisotropic phase part that is polymerized and cured in a state in which a polymerizable liquid crystal serving as a material is oriented and an isotropic phase part that is polymerized and cured in an isotropic state in which the polymerizable liquid crystal serving as a material is not oriented are arranged to be separated in a regional manner in a plane direction thereof, and that
the isotropic phase part is disposed in a region including at least a region predetermined to be sealed on the retardation control layer.

2. The display panel base material according to claim 1, wherein the isotropic phase part is formed only in the region predetermined to be sealed.

3. The display panel base material according to claim 1, wherein the sheet-shaped base material is one in which a color filter is laminated on an upper side of the base material.

4. The display panel base material according to claim 1, wherein a black matrix layer is formed on a base material of the sheet base material; a color filter layer is formed at least in a space part of the black matrix layer; and the retardation control layer is laminated on the color filter layer.

5. A method of manufacturing a display panel base material according to claim 1, comprising sequentially performing the steps of:
(a) applying an application liquid containing a polymerizable liquid crystal on a sheet-shaped base material to form a coating film;
(b) orienting the polymerizable liquid crystal of the coating film to allow the coating film to have anisotropy;
(c) selectively radiating an ionizing radiation such as ultraviolet rays onto the coating film allowed to have anisotropy, so as to polymerize and cure the polymerizable liquid crystal only at a part radiated with the ionizing radiation, so as to form an anisotropic phase part; and
(d) heating the sheet-shaped base material on which the coating film having the anisotropic phase part is formed, so as to allow a non-cured part of the coating film to undergo phase transition to make the part isotropic, and polymerizing and curing the non-cured part in that state to form an isotropic part.

6. The method of manufacturing a display panel base material according to claim 5, wherein a metal mask in which a frame-shaped frame part is formed in an inside of a frame-shaped outer frame is used in the step shown by (c), and the ionizing radiation is selectively radiated through the intermediary of the metal mask.

7. A display panel wherein a display panel base material according to claim 1 and an opposing base material are bonded through the intermediary of a seal material while keeping a predetermined gap in a region predetermined to be sealed on the display panel base material, and an inside thereof is filled with the liquid crystal and closely sealed.
